(19) United States
(12) Patent Application Publication
(10) Pub. No.: US 2020/0182314 A1
(43) Pub. Date: Jun. 11, 2020

(54) METHOD FOR ADJUSTING AN OPERATING POINT OF A HYDRAULIC ACTUATOR ARRANGEMENT

(71) Applicant: SCHAEFFLER TECHNOLOGIES AG & CO. KG, HERZOGENAURACH (DE)

(72) Inventors: Yunfan WEI, Bühl (DE); Marco GRETHEL, Bühlertal (DE); Markus BAEHR, Bühl (DE); Andre SCHAUER, Bühl (DE)

(73) Assignee: SCHAEFFLER TECHNOLOGIES AG & CO. KG, HERZOGENAURACH (DE)

(21) Appl. No.: 16/614,399

(22) PCT Filed: May 8, 2018
(86) PCT No.: PCT/DE2018/100433

§ 371 Date: Nov. 18, 2019

(30) Foreign Application Priority Data
May 30, 2017 (DE) 10 2017 111 717.2

(51) Int. Cl. F16D 48/06; B60W 10/02

(52) U.S. Cl. CPC F16D 48/066; F16H 61/688; B60W 10/02

(57) ABSTRACT

A method for adjusting an operating point of a hydraulic actuator arrangement, in which a volumetric flow source is connected to a hydraulic cylinder via a pressure line which is filled with a hydraulic fluid, wherein a volume of the hydraulic fluid is regulated via the volumetric flow source and the operating point corresponds to a position of the actuator arrangement for a predefined parameter of a device which is to be actuated by the actuator arrangement, wherein the volume of the hydraulic fluid which is required to adjust the operating point is derived from a rotational position of a volumetric flow source motor and/or the volumetric flow source. In a method which facilitates a reliable start of the volume determination, a volume determination is started by means of a rotary angle regulation at a predefined pressure, wherein the predefined pressure is lower than a system pressure.

### CROSS-REFERENCE TO RELATED APPLICATIONS

This application is the U.S. National Phase of PCT/DE2018/100433 filed May 8, 2018, which claims priority to DE 10 2017 111 717.2 filed May 30, 2017, the entire disclosures of which are incorporated by reference herein.

### TECHNICAL FIELD

The disclosure relates to a method for setting an operating point of a hydraulic actuator arrangement, in which a volume flow source is connected to a hydraulic cylinder via a pressure line filled with a hydraulic fluid, wherein a volume of the hydraulic fluid is regulated via the volume flow source, and the operating point corresponds to a position of the actuator arrangement for a predefined parameter of a device to be actuated by the actuator arrangement, wherein the volume of the hydraulic fluid that is required for setting the operating point is derived from a rotational position of a volume flow source motor and/or of the volume flow source.

### BACKGROUND

A method for setting and adapting an operating point of a hydraulic actuator arrangement is known from WO 2016/141935 A1. The hydraulic actuator arrangement is used here for actuating a clutch. A volume flow source in the form of a pump is connected via a hydraulic line to a hydraulic cylinder which acts on the clutch via an engagement bearing. Via the pump, hydraulic fluid is, from a hydraulic reservoir via a low-pressure hydraulic line, sucked in by the pump and supplied to the hydraulic cylinder via a high-pressure hydraulic line. A piston of the hydraulic cylinder is displaced by the hydraulic fluid, whereby the engagement bearing moves and the clutch is likewise displaced. The pump is driven by an electric motor on which an angle sensor is positioned, which angle sensor determines the rotational position of the electric motor in the form of a rotational angle. Here, the angle sensor may be in the form of a multiturn sensor, which also detects the rotational angle beyond 360°. A pressure sensor for measuring the pressure of the hydraulic liquid that is generated in the high-pressure hydraulic line is positioned in the hydraulic cylinder. The setting of the operating point is realized with this device by way of a regulating loop which comprises a combined pressure/travel regulation in which the regulation type is switched between pressure and rotational angle of the pump. Here, the pressure regulation is used in operating ranges with large pressure gradients. The pump angle regulation is realized in operating ranges with small pressure gradients.

A disadvantage here is that rotational angle regulation is started at different times, with the result that the operating point is not able to be set correctly.

### SUMMARY

The disclosure is based on the object of specifying a method for setting an operating point of a hydraulic actuator arrangement, in which reliable setting of the operating point in the rotational speed-regulated range is realized.

According to the disclosure, the object is achieved in that a volume determination by utilizing a rotational angle regulation is started at a predefined pressure, wherein the predefined pressure is less than a system pressure. At low pressure, the rotational angle regulator used is operational, and provides an accurate volume value at the time of the start of the regulation of the rotational angle. In the case of this regulation, use is made of the proportionality between the volume which is delivered by the volume flow source and the angular position of the volume flow source, wherein a predefined volume stroke per revolution of the volume flow source comprises a constant volume.

Advantageously, the volume determination is carried out with a fully open clutch. This ensures that the predefined pressure is reliably detected at all times.

In one configuration, the opening of the clutch is realized at a predefined speed from the time from which said clutch no longer transmits torque. With said predefined speed, it suffices for the volume flow source to suck in the hydraulic fluid at a constant rotational speed.

In one variant, the predefined speed is selected such that unintentional actuation of a gear of a transmission actuator is prevented. Unintended actuation of a gear would constitute an intervention in the driving situation of the vehicle and could lead to the vehicle being at risk.

In one embodiment, the actuator arrangement is moved at the predefined speed until attainment of a minimum position and/or a minimum pressure in the transmission actuator, wherein the actuator arrangement, upon attainment of the minimum position and/or minimum pressure, is deactivated. Since a hydraulically actuated selection piston of a transmission actuator has a very small working surface, it is highly sensitive to the displaced volume, and for this reason timely deactivation of the actuator arrangement is necessary to prevent unintentional gear setting.

In one refinement, after the opening of the clutch, the actuator arrangement, in the presence of a request for clutch closure, immediately runs up again, by the detected volume, to an operating point at which there is not quite a transmission of torque by the clutch. Since the rotational angle and thus the volume that were required with the opening of the clutch are known, it is possible by the known volume for the actuator arrangement to be easily activated in order for it to attain as quickly as possible the desired operating point at which the clutch transmits torque.

In a further variant, in the presence of a gear request, the clutch is opened at a maximum speed. Since, in this way, very quick attainment of the predefined minimum position of the actuator arrangement is made possible, very quick switching from the clutch strategy to a gear actuation strategy is possible in the vehicle.

In a further embodiment, the gear actuation is activated upon attainment of the minimum position and/or of the minimum pressure of the actuator arrangement. The minimum position or the minimum pressure thus constitutes a switching point for changing from the clutch strategy to the gear actuation strategy.

The maximum speed is advantageously reduced shortly before attainment of the minimum position and/or of a minimum pressure of the actuator arrangement. This measure also serves the purpose of ensuring that a gear is not unintentionally actuated and the actuator arrangement, upon attainment of the minimum position, really comes to a standstill.

In one variant, a directional control valve which actuates a gear is switched into a pass-through position during the clutch opening. Since, in this case, a gear is to be set as quickly as possible, the directional control valve, which is switched into a pass-through position, makes possible a direct connection between the gear setting and the actuator arrangement.

In one refinement, the volume of the hydraulic fluid that is required for setting the operating point is set via the rotational angle regulation below a predefined operating point and is set via a pressure regulation above the predefined operating point.

### BRIEF DESCRIPTION OF THE DRAWINGS

The disclosure permits numerous embodiments. It is sought to discuss one of these in more detail on the basis of the figures illustrated in the drawing.

In the drawing:

FIG. 1 shows an exemplary embodiment of a hydraulic clutch actuation device,

FIG. 2 shows an exemplary embodiment for a regulating loop operating the actuator arrangement,

FIG. 3 shows an exemplary embodiment of the method according to the disclosure.

### DETAILED DESCRIPTION

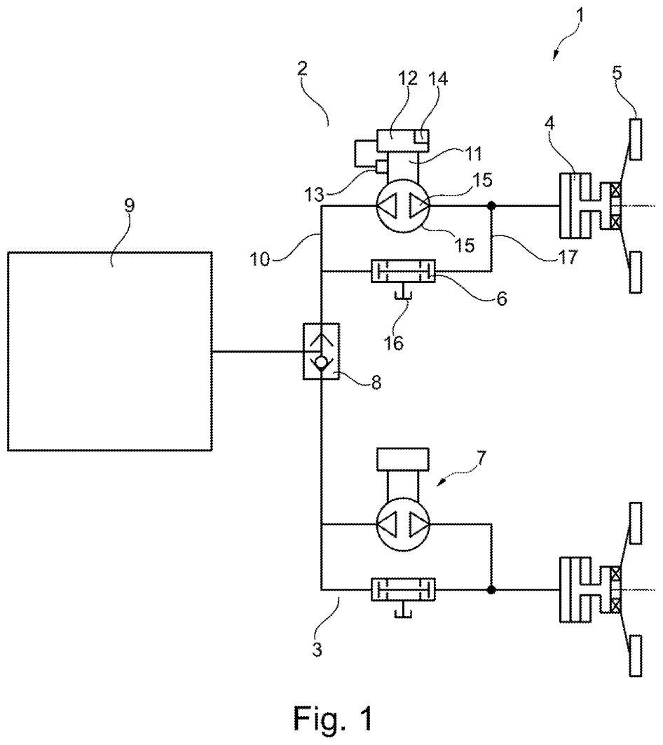

A pump actuator arrangement 1 is designed as a twin-engine double-clutch transmission in FIG. 1. Two partial strands 2, 3 are present in said double-clutch transmission, each of which comprises a hydraulic cylinder 4 which actuates a clutch 5. The respective hydraulic cylinder 4 of the clutch 5 is driven via a two-pressure valve 6, which is coupled to a pump actuator 7. The two partial strands 2, 3 are connected via a valve 8 to a transmission actuator 9.

Since both partial strands 2, 3 are of identical construction, only one partial strand shall be described below. In each partial strand 2, 3, a line 10 is connected to the pump actuator 7, which is driven by an electric motor 11. The electric motor 11, in turn, is activated by a control unit 12. A sensor 13 for determining the angle increments φ_{IST} covered by the electric motor 11 is arranged on the electric motor 11. The switching signals of the sensor 13 are counted by a counter 14 arranged in the control unit 12. The pump actuator 7 has a pump 15 which serves as a volume flow source and which is connected via the hydraulic line 2 to a hydraulic cylinder (not illustrated further) in the transmission actuator 9. Via the pump 15, hydraulic fluid is, from a hydraulic reservoir 16 via a line 17, sucked in and supplied to the transmission actuator 9 via the line 10.

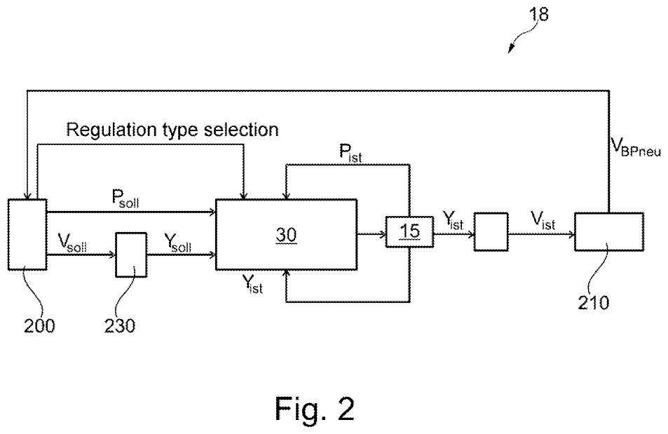

The illustrated hydraulic pump actuator arrangement 1 is actuated by a regulating loop 18, as is shown in FIG. 2. Said regulating loop 18 is configured in the control unit 12. A realization with combined pressure/travel regulation, in which the regulation type can be switched between pressure p and rotational angle φ of the pump 15, is illustrated. Instead of the pressure signal, any other signal x may also be used, for example a current of the electric motor 11, which is approximately proportional to the pressure. The pump angle regulation is realized in operating ranges with small pressure gradients, in particular during an air gap of the clutch 5, for which, although the clutch 5 is moved, it still does not transmit torque.

The switching between the regulation of the pressure p and the pump angle regulation φ is realized with an actuation of an open clutch 5 above a pressure limit. The selection of the respective regulating method is realized via a controller. The controller predefines a pressure target signal p_{SOLL} and/or a target volume V_{SOLL}. The regulation of the signal p is traditionally realized here with the regulating deviation between the pressure target value p_{SOLL} and the pressure actual value p_{IST}, which is output by the pump 15, taken into consideration. According to the selection output by the controller in the block 200, the corresponding output signal of the pressure regulation or of the rotational angle regulation is forwarded to the pump 15. With the aid of the rotational angle φ_{IST} determined at the pump 15 and of the pressure signal p_{IST}, adaptation of a volume V_{BPneu} for the setting of a new operating point (block 210) is realized. This new volume V_{BPneu} of the hydraulic fluid is supplied to the controller in the block 200, which controller determines from the new volume V_{BPneu}, which corresponds to a specific operating point, the target value V_{SOLL} of the volume V. In the block 230, the target volume V_{SOLL} is converted into a target angle φ_{SOLL} via the pump characteristic value volume per angle. The difference between this actual rotational angle φ_{IST}, which is measured by the sensor 13, and the newly calculated target angle φ_{SOLL} forms the input of the rotational angle regulation in the block 30.

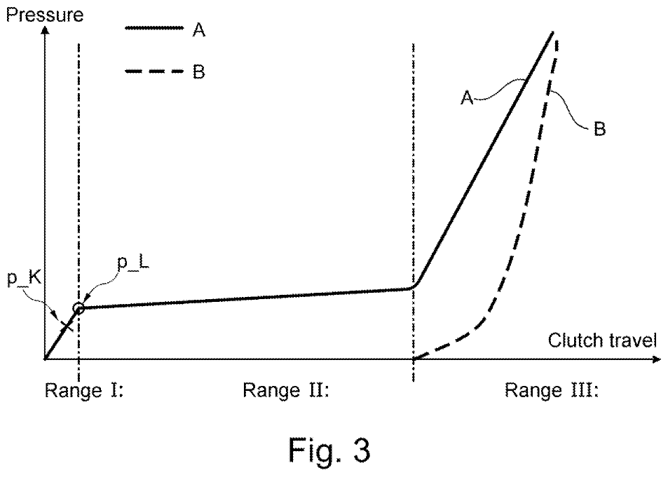

The method according to the disclosure shall be discussed in more detail in conjunction with FIG. 3. FIG. 3 illustrates a pressure/travel characteristic curve of the hydraulic pump actuator arrangement 1, which has three ranges. Range I shows here the pressure increase phase. The range II corresponds to the air gap of the clutch 5, for which, although the clutch 5 is moved, it still does not transmit torque. In this range, a small pressure gradient occurs, and for this reason the rotational angle regulation is carried out. The range III begins with an actuator position at which the clutch 5 begins to transmit a torque. The clutch pressure is in this case indicated by the characteristic curve A, while the clutch torque to be transmitted is indicated by the characteristic curve B. In order to set the exact time from which the rotational angle regulation is started, the pressure p in the pump actuator arrangement 1 is measured. If the measured pressure p_K is less than a pressure p_L, the rotational angle regulation is activated. This is realized in the range I of the clutch characteristic curve.

It is sought to start the rotational angle regulation already at a pressure p close to 0. However, owing to the measurement accuracy of the sensor 13, this is not always possible, and for this reason, in the present exemplary embodiment, the pressure p_K for the start of the rotational angle regulation is situated in the middle of the pressure increase phase in the range I.

Upon attainment of this predefined pressure value p_K, the clutch 5 may be fully open. With the opening of the clutch 5, from the time from which the clutch 5 no longer transmits torque (departure from the range III in the direction of range II), the pump actuator arrangement 1 is moved at an appropriate speed further in the direction of low actuator positions. Here, the pump 15 sucks in the hydraulic fluid at a rotational speed. As soon as the pump actuator arrangement 1 has attained a predefined minimum position, the electric motor 11 is no longer electrically energized and is deactivated, whereby also the clutch 5 comes to a standstill since the pump actuator arrangement 1 no longer moves. This avoids a situation in which, even at a reduced speed, the clutch 5 is opened, whereby a selection piston (not illustrated further) of the transmission actuator 9 is moved, which would lead to unintentional engagement of a gear.

If it is ensured that the clutch 5 is fully open, the predefined pressure p_K can be reliably detected. However, if a gear actuation is requested during such a process, the clutch 5 has to be opened at a maximum speed. In this case, dynamics, which are lost with the rotational speed limitation or the stoppage of the electric motor 11, are ensured. However, here too, the minimum position of the pump actuator arrangement 1 may be monitored in order to prevent a gear actuation by the transmission actuator 9. Therefore, the maximum speed of the pump actuator arrangement 1 or the rotational speed of the electric motor 11 is reduced in a timely manner to avoid uncontrolled selection piston actuation.

For the purpose of ensuring quick switching between a clutch strategy and a gear actuation strategy, a directional control valve which is used for actuating the gear is switched into a pass-through position, with the result that, at the maximum speed of the pump actuator arrangement 1, a gear can be swiftly engaged.

### LIST OF REFERENCE SIGNS

1 Pump actuator arrangement

2 Partial strand

3 Partial strand

4 Hydraulic cylinder

5 Clutch

6 Two-pressure valve

7 Pump actuator

8 Valve

9 Transmission actuator means

10 Line

11 Electric motor

12 Control unit

13 Sensor

14 Counter

15 Pump

16 Hydraulic reservoir

17 Line

18 Regulating loop

1. A hydraulic actuator arrangement, comprising:
a volume flow source connected to a hydraulic cylinder via a pressure line filled with a hydraulic fluid, wherein the volume flow source is configured to regulated a volume of the hydraulic fluid, and configured to set an operating point that corresponds to a position an actuator arrangement for a predefined parameter of a clutch to be actuated by the actuator arrangement, wherein the volume of the hydraulic fluid that is required for setting the operating point is derived from a rotational position of a volume flow source motor or of the volume flow source, and a volume determination via a rotational angle regulation is started at a predefined pressure, wherein the predefined pressure is less than a system pressure.

2. The hydraulic actuator arrangement of claim 1, wherein the volume determination is carried out with a fully open clutch.

3. The hydraulic actuator arrangement of claim 2, wherein the clutch is configured to open at a predefined speed from a time from when the clutch no longer transmits torque.

4. The hydraulic actuator arrangement of claim 3, wherein the predefined speed is selected such that unintentional actuation of a gear of a transmission actuator is prevented.

5. The hydraulic actuator arrangement of claim 3, wherein the actuator is configured to move at the predefined speed until attainment of a minimum position or a minimum pressure in a transmission actuator, wherein the actuator arrangement is configured to be deactivated in response to attainment of the minimum position or minimum pressure.

6. The hydraulic actuator arrangement of claim 1, wherein, after opening of the clutch, the actuator arrangement, in response to a request for clutch closure, immediately runs up again, in response to a detected volume, to an operating point at which there is not a transmission of torque by the clutch.

7. The hydraulic actuator arrangement of claim 1, wherein the clutch is opened at a maximum speed in response to a gear request.

8. The hydraulic actuator arrangement of claim 7, wherein the maximum speed is reduced shortly before attainment of the minimum position or of the minimum pressure of the actuator arrangement.

9. The hydraulic actuator arrangement of claim 7, wherein the hydraulic actuator arrangement includes a directional control valve which actuates a gear is switched into a pass-through position during the clutch opening.

10. The hydraulic actuator arrangement of claim 9, wherein the volume of the hydraulic fluid that is required for setting the operating point is set via the rotational angle regulation below a predefined operating point and is set via a pressure regulation above the predefined operating point.

11. A method for setting an operating point of a hydraulic actuator arrangement, comprising:
connecting a volume flow source to a hydraulic cylinder via a pressure line filled with a hydraulic fluid;
regulating a volume of the hydraulic fluid via the volume flow source;
setting the operating point to a position of the actuator arrangement for a predefined parameter of a clutch configured to be actuated by the actuator arrangement; and
deriving the volume of the hydraulic fluid that is required for setting the operating point from a rotational position of a volume flow source motor or of the volume flow source.

12. The method of claim 11, wherein the method includes the step of selecting a predefined speed so that unintentional actuation of a transmission actuator is prevented.

13. The method of claim 11, wherein the method includes the step of moving a predefined speed until attainment of a minimum position in a transmission actuator.

14. The method of claim 11, wherein the method includes the step of moving a predefined speed until attainment of a minimum pressure in a transmission actuator.

15. The method of claim 11, wherein the method includes the step of opening the clutch at a maximum speed in response to a gear request.

16. The method of claim 11, wherein the method includes the step of the volume of the hydraulic fluid that is required for setting the operating is further in response to a rotational angle regulation meeting a predefined pressure, wherein the predefined pressure is less than a system pressure.

17. The method of claim 11, wherein the method includes the step of setting the volume of the hydraulic fluid that is required for setting the operating point in response to a rotational angle regulation falling below a predefined operating point and set via a pressure regulation above the predefined operating point

18. A method for setting an operating point of a hydraulic actuator arrangement, comprising:
connecting a volume flow source to a hydraulic cylinder via a pressure line filled with a hydraulic fluid;
regulating a volume of the hydraulic fluid via the volume flow source;
setting the operating point in response to a position of the hydraulic actuator arrangement for a predefined parameter of a clutch to be actuated by the hydraulic actuator arrangement; and
determining the volume of the hydraulic fluid that is required for setting the operating point in response to a rotational angle regulation meeting a predefined pressure that is less than a system pressure.

19. The method of claim 18, determining the volume is carried out with a fully open clutch.

20. The method of claim 18, wherein the clutch is configured to open at a predefined speed from a time from when the clutch no longer transmits torque.
